(19) United States
(12) Patent Application Publication
(10) Pub. No.: US 2017/0357920 A1
(43) Pub. Date: Dec. 14, 2017

(54) METHOD AND SYSTEM FOR ESTIMATING AND MAPPING WEATHER RISK

(71) Applicant: Douglas Stewart, LANTANA, FL (US)

(72) Inventor: Douglas Stewart, LANTANA, FL (US)

(21) Appl. No.: 15/177,407

(22) Filed: Jun. 9, 2016

(51) Int. Cl. G06Q 10/06; G01W 1/10

(52) U.S. Cl. CPC G06Q 10/0635; G01W 1/10

(57) ABSTRACT

A method for estimating and mapping weather risk for a business entity includes receiving the weather elements, the temporal and spatial weather specifications and the business metric, from a user through an interface. Based on these user inputs, the weather element data is retrieved from available weather databases. The weather element data is processed through the temporal and spatial weather specifications to generate a plurality of weather indices, the weather indices being a plurality of n-dimensional weather feature vectors. Thereafter, the dimensionality of the weather indices is reduced to generate a time series of weather features which are further mapped in a spatially coherent fashion onto a grid of nodes of a Self-Organizing Feature Map (SOFM) and each node is associated with an analog set of weather features. Finally, a business metric distribution for each node's set of analog set of weather features is generated, based on the received business metric.

### TECHNICAL FIELD

The presently disclosed embodiments are directed to weather forecasting, and more particularly to estimating and mapping weather risk for a weather-sensitive entity.

### BACKGROUND

The uncertain and chaotic nature of weather is well-known to everyone. In today's world, almost every business is dependent on weather conditions. Such business industries include but are not limited to, agriculture, transportation, construction, retail sales, and wholesale market. In all such business industries, the operations and profits can be significantly affected by uncooperative weather. For example, a shipment by the sea may get affected by the unexpected rain, unusually mild winters may diminish the demand for heating appliances, and so on. Unexpected weather events can negatively impact revenues, increase inventory costs, erode the profit margins for such companies, and thus, cause significant financial losses. Weather forecasting may be helpful in reducing the impact that adverse weather may have on any industry/business entity.

An existing weather forecasting system employs a hierarchical artificial neural network (HANN) for identifying storm events from spatial precipitation patterns, derived from conventional volumetric radar imagery. However, it lacks to provide the weather data oriented to a particular business, is highly complex, and is not cost effective. Another existing weather risk assessment system performs the financial risk analysis for a business model using weather risk assessment engine. However, the determination of which information to utilize to assess particular risks is a challenging task. The specific information about specific risks tailored to specific companies is not readily available.

Hence, there exists a need for a system that overcomes the limitations of existing systems and provides business oriented weather information for any business model/entity for any location and time, and not just a general weather forecast data.

### SUMMARY

The present disclosure discloses systems and methods for estimating weather risk.

According to an aspect of the present disclosure, a computer-implemented method for estimating and mapping weather risk for a business entity is provided. The computer-implemented method includes receiving one or more weather elements, one or more temporal and spatial weather specifications, and one or more business metric, from a user, and retrieving weather element data from one or more weather databases based on user input. The computer-implemented method further includes generating a plurality of weather indices by processing the weather element data through the one or more temporal and spatial weather specifications, the plurality of weather indices being a plurality of n-dimensional weather feature vectors, and performing dimension reduction of the plurality of weather indices to generate a time series of one or more weather features. The computer-implemented method furthermore includes mapping the one or more weather features in a spatially coherent fashion onto a grid of nodes of a Self Organizing Feature Map (SOFM), each node being associated with an analog set of weather features, and generating business metric distribution for each node's set of analog set of weather features, based on the one or more business metric.

According to another aspect of the present disclosure, a computer-implemented method for estimating and mapping weather risk for a business entity is provided. The computer-implemented method includes focussing a plurality of historical weather elements into business specific weather using one or more temporal and spatial processing templates; dispersing historical business weather onto a Self Organizing Feature Map (SOFM) in an ordered fashion; and outputting one or more business metric associated with the dispersed business weather.

According to yet another aspect of the present disclosure, a weather risk mapping (WRM) system is disclosed. The WRM system includes a weather element selection module configured to receive one or more weather elements from a user; a temporal and spatial template application module configured to receive one or more temporal and spatial weather specifications from a user; a weather database module configured to retrieve weather element data from one or more weather databases based on user input; a weather index computation module configured to generate a plurality of weather indices by processing the weather element data through the one or more temporal and spatial weather specifications, the plurality of weather indices being a plurality of n-dimensional weather feature vectors; a weather feature generation module configured to perform dimension reduction of the plurality of weather indices to generate a time series of one or more weather features; and a SOFM algorithm module configured to: map the one or more weather features in a spatially coherent fashion onto a grid of nodes of a Self Organizing Feature Map (SOFM), each node being associated with an analog set of weather features; and generate business metric distribution for each node's set of analog set of weather features, based on the one or more business metric.

### BRIEF DESCRIPTION OF DRAWINGS

FIG. 1 is a block diagram illustrating a system environment, wherein various embodiments of the present disclosure can be practiced;

FIG. 2 is a block diagram illustrating a Weather Risk Mapping (WRM) system for estimating and mapping weather risk, in accordance with an embodiment of the present disclosure;

FIG. 3 illustrates an exemplary weather element selection form of the WRM application of FIG. 2, in accordance with an embodiment of the present disclosure;

FIG. 4 illustrates an exemplary linear temporal template input form of the WRM application of FIG. 2, in accordance with an embodiment of the present disclosure;

FIG. 5 illustrates an exemplary nonlinear temporal template input form of the WRM application of FIG. 2, in accordance with an embodiment of the present disclosure;

FIG. 6 illustrates an exemplary spatial profile template form of the WRM application of FIG. 2, in accordance with an embodiment of the present disclosure;

FIG. 7 illustrates an exemplary spatial location template form of the WRM application of FIG. 2, in accordance with an embodiment of the present disclosure;

FIG. 8 illustrates an exemplary map with node parameter template in accordance with an embodiment of the present disclosure;

FIG. 9 illustrates the weather risk mapping (WRM) processes being executed at the front end, and at the back end, in accordance with an embodiment of the present disclosure;

FIG. 10 illustrates conceptualization of the WRM processes using a lens/prism and filter, in accordance with an embodiment of the present disclosure;

FIG. 11 illustrates a two-dimensional SOFM neuron lattice;

FIG. 12 illustrates a sample histogram with a non-parametric PDF construction;

FIG. 13 illustrates an example of five random draws of sample size M from the historical distribution, in accordance with an embodiment of the present disclosure;

FIG. 14 depicts an illustrative definition of excess probability at a particular node, in accordance with an embodiment of the present disclosure;

FIG. 15 illustrates sample PDF and EDF for a forecast business metric distribution, in accordance with an embodiment of the present disclosure;

FIG. 16 illustrates tabulated exceedance probability, in accordance with an embodiment of the present disclosure;

FIG. 17 illustrates 1- and 2-dimensional SOFM maps depicting the residence density, in accordance with an embodiment of the present disclosure;

FIG. 18 illustrates 1- and 2-dimensional SOFM maps depicting the business metric distributions' expectation across all nodes, in accordance with an embodiment of the present disclosure;

FIG. 19 illustrates 1- and 2-dimensional SOFM maps depicting the business metric distributions' standard deviation across all nodes, in accordance with an embodiment of the present disclosure;

FIG. 20 illustrates exemplary weather index and weather feature distributions at a particular node, in accordance with an embodiment of the present disclosure;

FIG. 21 illustrates an example of forecast weather index and feature distributions at a particular set of nodes, in accordance with an embodiment of the present disclosure;

FIG. 22 illustrates a 1-dimensional SOFM map of residence density with nodes occupied by ensemble forecast members indicated using a histogram, in accordance with an embodiment of the present disclosure;

FIG. 23 illustrates a 2-dimensional SOFM map of residence density with nodes occupied by ensemble forecast members indicated numerically on each node, in accordance with an embodiment of the present disclosure;

FIG. 24 illustrates a 1-dimensional SOFM map of metric expectations with nodes occupied by ensemble forecast members indicated using a histogram, in accordance with an embodiment of the present disclosure;

FIG. 25 illustrates a 2-dimensional SOFM map of metric expectation with nodes occupied by ensemble forecast members indicated numerically on each node, in accordance with an embodiment of the present disclosure;

FIG. 26 is a flowchart illustrating a method for estimating and mapping weather risk, in accordance with an embodiment of the present disclosure;

FIG. 27 is a flowchart illustrating a method for estimating and mapping weather risk, in accordance with another embodiment of the present disclosure; and

FIG. 28 illustrates an overview of the web page structure and content of the WRM application executing in the WRM server of FIG. 1, in accordance with an embodiment of the present disclosure.

### DETAILED DESCRIPTION

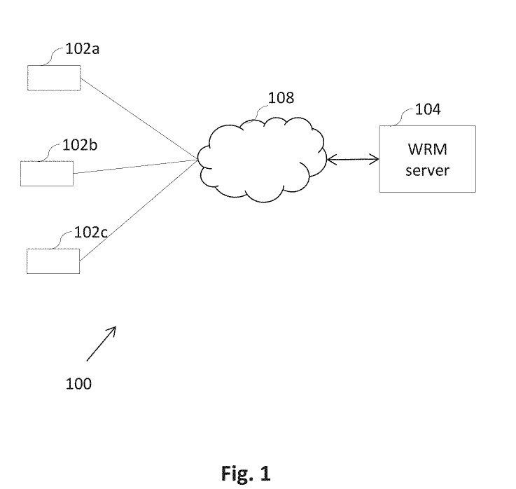

Referring to Figures, FIG. 1 is a block diagram illustrating a system environment 100, wherein various embodiments of the present disclosure can be practiced. The system environment 100 includes first through third client devices 102a, 102b and 102c, hereinafter referred to as client devices 102, and a Weather Risk Mapping (WRM) server 104. A client device 102 may include a variety of computing devices, such as a personal computer, a laptop, a mobile phone, tablet, PDA, a smart-phone or any other device capable of data communication. It will be apparent to a person skilled in the art that further client devices 102 may be added to the environment 100, without limiting the scope of the disclosure.

The client devices 102 and the WRM server 104 are communicatively coupled to each other via a communication network 108. Examples of the communication network 108 include wired or wireless network, such as but not limited to, a Local Area Network (LAN), a Wide Area Network (WAN), a Wi-Fi network and so forth.

The WRM server 104 may refer to a remote device that includes a processing unit and a memory for partially or wholly, executing all the requisite computations pertaining to weather risk mapping for business entities. A WRM application of the WRM server 104 may be executed either locally or as a web-based application on the client devices. The WRM application incorporates an innovative combination of weather data sources, weather type depiction and weather/metric association to provide to provide the following functionality:
a) Quantitative assessment of non-catastrophic weather risk for any weather-sensitive business, enterprise, or entity (all hereafter referred to as “business”).
b) Updated monitoring of weather risk over a recent period of time.
c) Updated forecasts of weather risk for a future period of time.

In an example, the WRM application may be developed for Mac OSX operating system, with computer code written in a combination of FORTRAN, C, Mathematica (including MathLink), HTML, Javascript, and CSS. The scripts for the WRM application may be written in C-shell environment with standard UNIX commands, with the web-viewing being developed for Safari and Firefox browsers. Further, the memory on the development computer running OS10.9.5 may be 128 GB, with external storage in RAIDS configuration exceeding 12 TB.

In an embodiment, the WRM application is configured to run with web-only clients as well as licensed clients. For the licensed clients, generally all the operations and computations pertaining to weather risk mapping (with the exception of historical data updates) execute locally on their device. Since the WRM application runs in-house at the client's facility, with no front-end access from the Internet, no access restrictions may be imposed, and licensed clients, at their discretion, may set up internal access restrictions on their internal network. The datasets may be maintained by the WRM server 104 and may be updated monthly upon availability of the most recently completed month's data. After running through the preprocessors to extract weather element data, the daily updated recent and forecast datasets may be uploaded to the ISP for use by licensed clients, so that weather risk assessment on newly created profiles may be run daily at the client's facility.

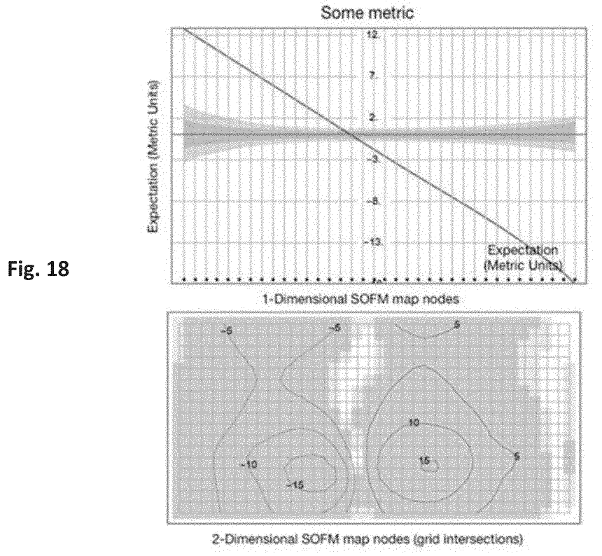

In another embodiment, a web-based client has access only to the front-end processing through a web browser. All back-end processes for such web-based client may be executed at the WRM server 104. For web-only clients, the back-end process for the assessment and daily updates include uploading data, images, and tables to an appropriate internet service provider (ISP), distributing the content to appropriate client directories, and installing appropriate access restrictions. The web-based client has subscription-based access to corresponding WRM website that allows them private access to their current weather risk information through the browser front end. The front end and back end processes pertaining to weather risk mapping for a web-based client has been further explained in detail with reference to FIG. 18.

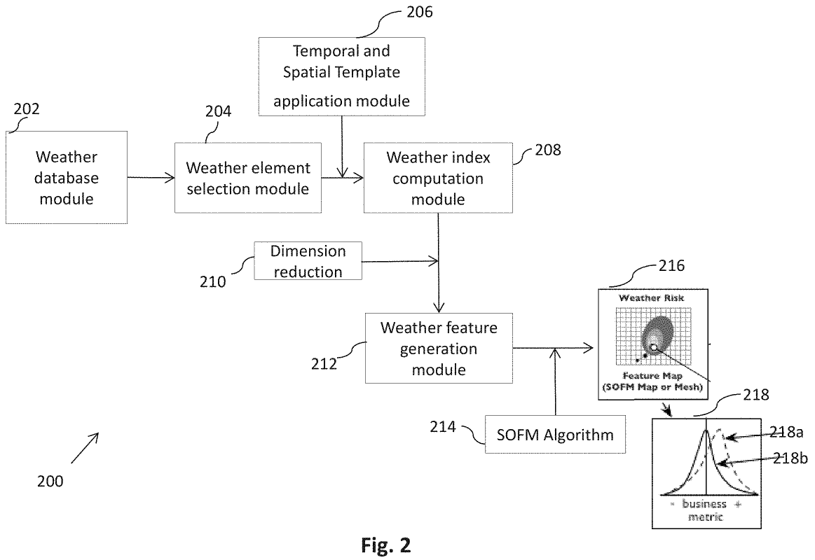

FIG. 2 is a block diagram illustrating a Weather Risk Mapping (WRM) application 200 executing either locally or as a web-based application on a client device 102, in accordance with an embodiment of the present disclosure. The WRM application 200 includes a weather database module 202, a weather element selection module 204, a temporal and spatial template application module 206, a weather index computation module 208, a dimension reduction algorithm module 210, a weather feature generation module 212, a Self-Organizing Feature Mapping (SOFM) algorithm module 214, a feature map 216, and a business metric distribution graph 218.

The weather database module 202 is configured to store historical, recent and future weather data information of all the locations of interest. In an example, various global and/or regional models, such as North American Regional Reanalysis (NARR) model, can be used as data sources for generating global and/or some other regional gridded data. The data from these models include historical weather elements, routinely updated recent weather elements, and ensemble forecast weather elements and may be extracted from corresponding data sources based on the user's preferences. In an example, all historical datasets may be derived from 4-dimensional data assimilation schemes that may be dynamically and thermodynamically consistent, as they may be used either for computer weather model initialization or they represent 3-hour forecasts from the models. The gridded data sets are generated by U.S government agencies and are publicly available as binary downloads from the Internet. Other gridded data sources may be substituted for the U.S. sources. This differs from conventional weather risk evaluation, which depends on station observations of weather elements.

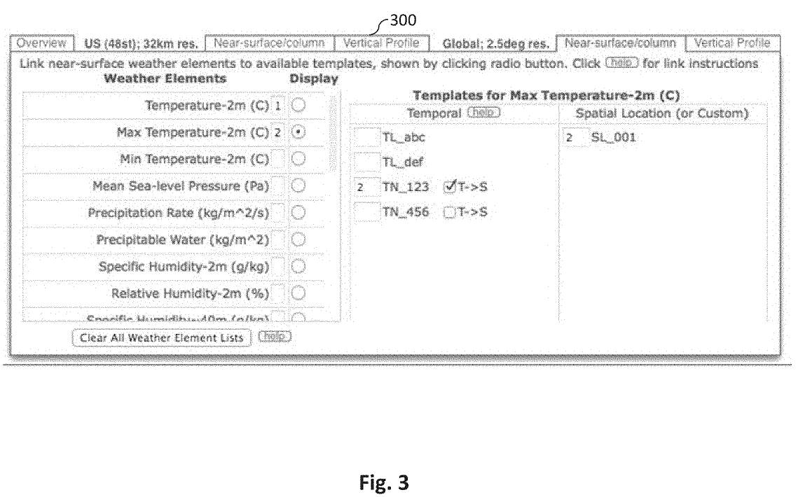

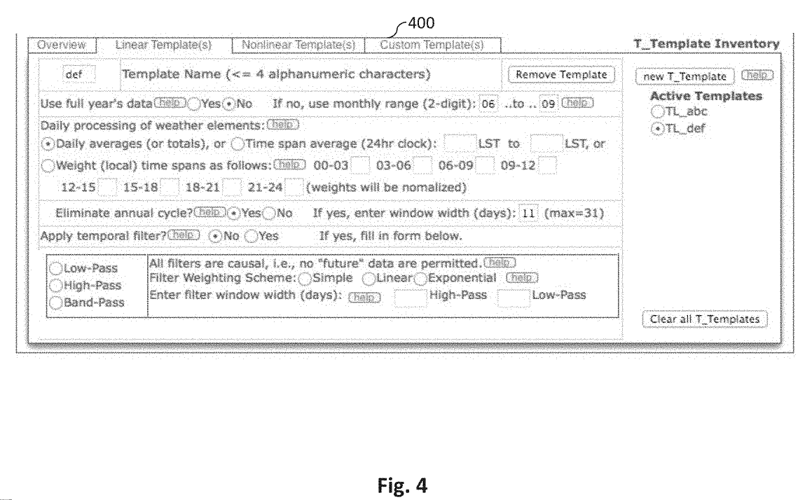

The weather element selection module 204 enables a user to select at least one weather element from a pre-specified list of weather elements. Examples of the weather elements include, but are not limited to, temperature, maximum temperature, minimum temperature, mean sea-level pressure, precipitation rate, precipitation rate, precipitable rate, specific humidity, and relative humidity. In an embodiment, the weather element selection module 204 provides a user interface on a client device 102 such as the first client device 102a for enabling the user to select at least one weather element. An example of a weather element selection form 300 is illustrated with reference to FIG. 3. The weather element selection form 300 includes a list of weather elements, each provided along with a selective display option. The user may select any number of the weather elements as per their business requirements. Also, these weather elements may be linked to particular spatial and temporal templates explained in detail further with reference to FIGS. 4-7.

Referring back to FIG. 2, the temporal and spatial template application module 206 enables the user to determine spatial and temporal processing to be applied to the selected weather elements through a series of templates available. In an embodiment, the temporal and spatial template application module 206 enables display of one or more template forms on the user interface of the user computing device such as the first client device 102a. For highly specialized applications, the time resolution, spatial and temporal templates, and weather element selection may be highly customized with consultation with a WRM personnel. An example of a linear temporal template input form 400 is illustrated in FIG. 4.

The linear temporal template input form 400 enables the user to specify how the historical weather data/meteorological data should be processed in time. For example, the user may choose to eliminate the annual cycle from the weather data. Further, the user may specify how the daily processing of weather elements should be performed by selecting one of daily averages and time span averages, selecting various time filters, and so on. Furthermore, the user may create a new template, select a particular template and/or clear a template. The user may select the time frame as their business metric permits, preferably daily, weekly, and monthly resolutions, with annual synchronization options. Higher resolution and a longer business metric history may produce more statistically meaningful results.

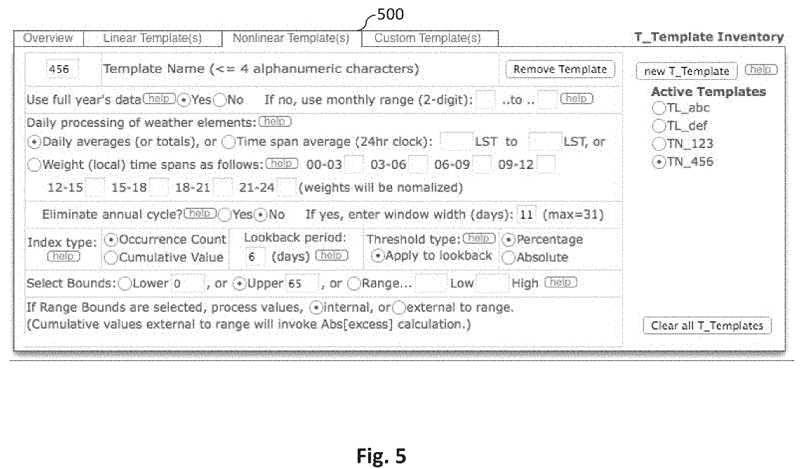

An example of a non-linear temporal template input form 500 is illustrated in FIG. 5. The non-linear temporal template input form 500 prompts the user to specify an application order of the temporal and spatial templates for data preprocessing. The nonlinear template type allows the user to process historical weather data into threshold or occurrence exceedances.

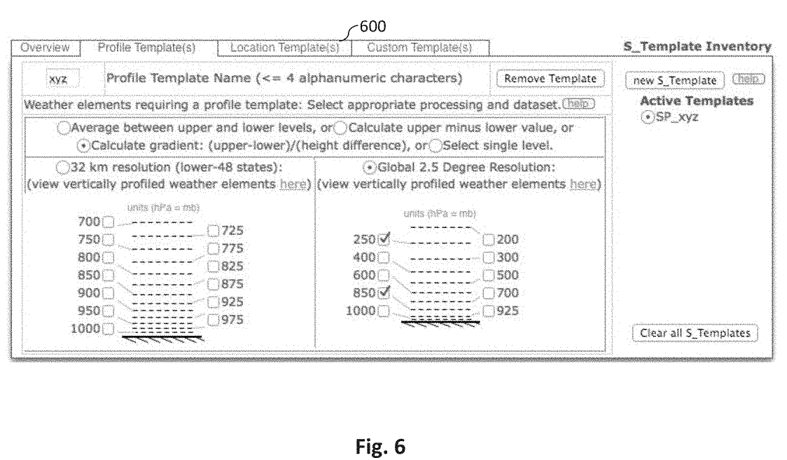

An example of a spatial profile template input form 600 is illustrated in FIG. 6. The spatial profile template input form 600 allows users to access data at different vertical levels. The spatial profile-type template form 600 is presented to the user, when upper air meteorological elements are selected by the user. As shown in FIG. 6, the user can select among appropriate processing procedures for selecting and/or combining data at various levels.

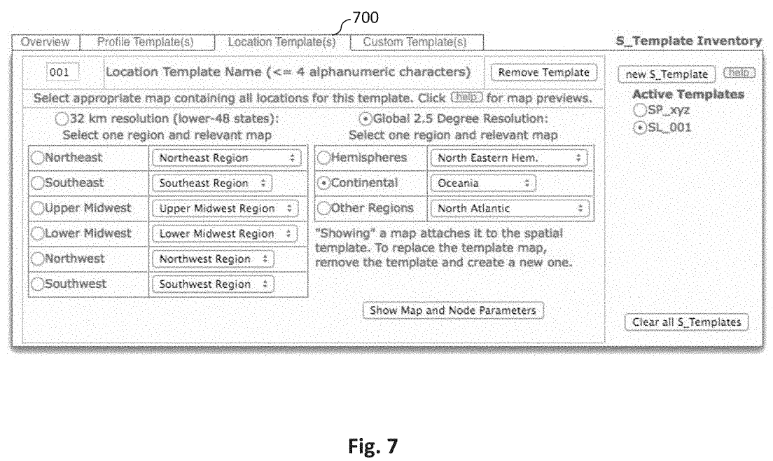

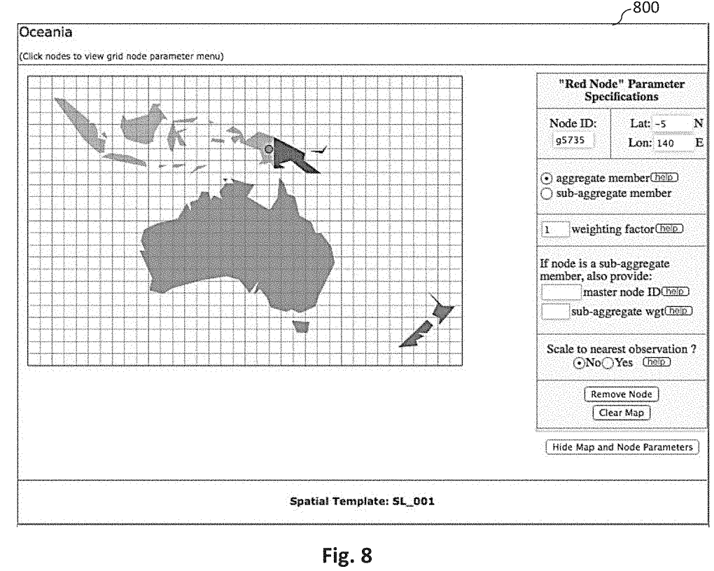

An example of a spatial location template form 700 is illustrated in FIG. 7. Numerous maps are available for selecting one or more locations for weather risk mapping. The data from these locations may be weighted differently to reflect different populations or any other spatial factor that influences the aggregate business metric. As shown in FIG. 7, the spatial location template form 700 enables the user to select an appropriate map by selecting a continent, and a corresponding region in corresponding datasets of 32 km resolution (lower-48 states) and/or Global 2.5 degree resolution. The “show map and node parameters” icon may generate a map as shown in FIG. 8. An example map 800 with its node specification parameter template is shown in FIG. 8. By using this node specification parameter template, the user can easily provide proper weighting of the data at that node.

Referring back to FIG. 2, the user may provide one or more specifications through one or more temporal and spatial template forms 400 till 700. The weather index computation module 208 produces n-dimensional feature vectors by applying spatial and temporal template specifications to business specific weather elements. In an embodiment, the weather index computation module 208 focuses the available historical weather data into one or more indices of business weather, the business weather being a weather unique or preferable to a particular business or enterprise. For example, for a heating appliance manufacturer, the business weather is winter temperature.

The weather feature generation module 212 applies the dimension reduction algorithm 210 to the weather indices to generate a set of weather features. When the weather index vectors are high dimensional (i.e., two or more weather indices), the weather index vectors are converted to weather feature vectors using a principle component analysis (PCA) to reduce linear dependency, which is removed completely for 2-dimensional index vectors, and reduced substantially for higher dimensional index vectors (i.e., two or more indices) by minimizing the unexplained variance in a reduced dimensional representation of the feature vector. This dimensionality reduction can be very useful for visualizing and processing high-dimensional vectors, while still retaining as much of the variance in the vector as possible.

This final historical weather feature vector set represents the business weather, which is then processed by the SOFM algorithm module 214 to generate a weather feature map 216. The weather feature map 216 is a SOFM map that consists of an array of nodes, each containing a historical analog subset of business weather. The subsets of business weather at proximate nodes consist of slightly different business weather, whereas historical analogs at distant nodes differ considerably.

The SOFM algorithm module 214 employs a neural network that maps a historical feature vector onto a 1- or 2-dimensional mesh of nodes. The 1-dimensional mesh is used for one weather index (which is equal to its 1-dimensional feature vector), while feature vectors of two or more dimensions are mapped onto a 2-dimensional mesh.

The SOFM procedure takes a historical weather feature time series, and “maps” the historical record onto the lattice of nodes. Each weather feature in the time series is a vector of one or more dimensions. The nodes of the network are assigned weight vectors with dimensions equal to the feature vector dimension. These nodes are initialized with random weights, which are modified during the training procedure. The historical feature vectors, which are standardized and normalized by their fractional contribution to the total variance, are randomly presented to the mesh over millions of iterations, and for each iteration, the node containing the weight vector “closest” to the weather feature (in a least-squares sense) wins that iteration. So, the winning node is that node with a minimum separation from the feature vector according to a Euclidian norm distance measure. The winning node's weight vector is nudged closer to the weather feature vector and the weight vectors of neighboring nodes are nudged to a lesser extent toward the weather feature's vector. As a result, over millions of iterations, each node becomes associated with a set of weather features (i.e., a historical weather analog set) whose vector values are similar. The sets of historical weather analogs from nearby nodes do not differ substantially as compared to the sets of weather analogs from distant nodes on the map. This SOFM procedure disperses, or “maps,” the historical weather data in a spatially coherent fashion onto a grid of nodes. The functionality is analogous to the function of a prism, which disperses sunlight in an ordered fashion (by wavelength) onto a surface.

The business metric distribution graph 218 is obtained by extracting the relevant business metric from the feature map 216. Examples of business metric include, but are not limited to, profit, loss, revenue, and labor. First, these input business metrics may be screened by having all known non-weather-related variability removed.

Once the historical weather is mapped through the feature map 216, any recent or forecast weather may be processed using the modules 204 till 214 and is positioned at a node of the map 216. The weather risk is expressed as node-dependent business metric distributions 218a that are shifted favorably or unfavorably relative to the business metric distribution 218b associated with all historical business weather. The average and standard deviation of each node's metric distribution vary across the map. A quantitative measure of the efficacy of the assessment process is dependent on the difference between each node's metric distribution and the historical metric distribution summed across all nodes of the map.

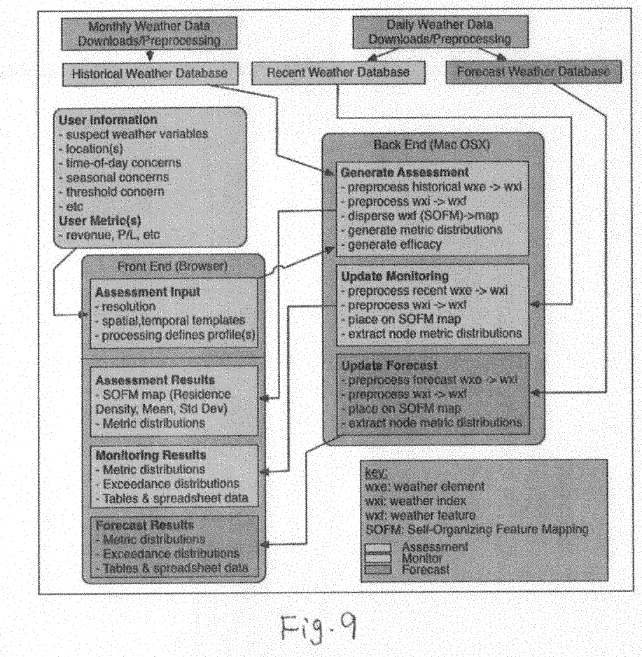

FIG. 9 illustrates the weather risk mapping (WRM) processes 900 being executed at the front end, i.e. at the client device 102 and at the back end, i.e. at the WRM server 104. The user feeds in various input data and business metric 902 through the front end, i.e. a web browser 904. At the front end, the client/user is provided with four weather risk services: assessment input, display of assessment, monitoring and forecast results. Using the browser 904, the user may access appropriate node information and produce metric distribution plots, exceedance tables, and spreadsheet files for examination or subsequent analysis. This constitutes the quantitative weather risk estimates.

The processes at the back-end 906 receive data from historical weather database 908, recent weather database 910, and forecast weather database 912. The daily updated processing of recent and forecast weather risk, including the generation of all images and tables, also runs at the back end 906. In all of the processing at the back end 906, the prior available weather data is preprocessed to obtain the selected weather element data matching the business metric. The weather elements are converted to weather index through application of the time resolution and template configurations. Further, the weather indices are pre-processed to reduce the higher dimensionality and produce a set of weather features. Then, the SOFM algorithm is applied to the weather features to generate information content at each node of the SOFM map, including its associated metric distributions and statistics. Results of the assessment (including all profile input data and SOFM execution information) are transferred to the front-end 904 for viewing. Once the historical data is processed, recent weather data may be processed for the most recent seven time periods (e.g. days—if daily time resolution is selected) to monitor recent weather risk, and sixteen-day forecasts and extended range weather forecast data may be processed in a similar manner as the recent data to produce quantitative weather risk forecasts.

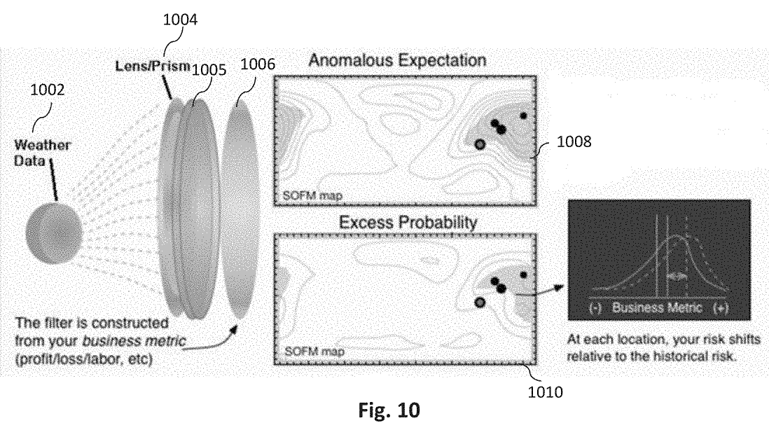

Referring to FIG. 10, the WRM method of weather risk analysis may be conceptualized as passing historical weather data 1002 through a lens and prism configuration 1004 and 1005 and then a filter 1006. The lens 1004 “focuses” all available weather elements into business-specific weather using temporal and spatial processing templates as illustrated in FIGS. 3-7. The prism 1005 “disperses” the historical business weather data 1002 onto a 1- or 2-dimensional feature maps 1008 and 1010 (similar to the feature map 216) in an ordered fashion, much as a prism disperses sunlight onto an image ordered by wavelength. Further, the filter 1006 passes only the business metric associated with the dispersed business weather. For example, the filter 1006 passes only one (of possibly many) business metrics.

Once the historical weather is mapped in this manner, any recent or forecast weather is processed through the lens/prism and filter and is positioned at a node of the map. The weather risk is expressed as node-dependent business metric distributions that are shifted favorably or unfavorably relative to the business metric distribution associated with all historical business weather. The average and standard deviation of each node's metric distribution vary across the map. A quantitative measure of the efficacy of the assessment process is dependent on the difference between each node's metric distribution and the historical metric distribution summed across all nodes of the map.

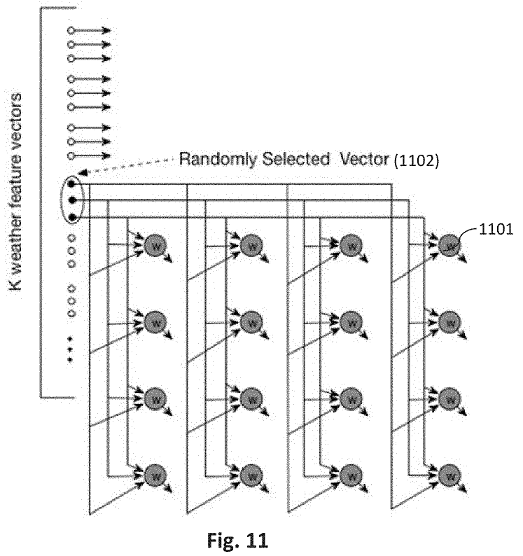

FIG. 11 illustrates a two-dimensional SOFM neuron lattice. Here, there are N=16 neurons 1101 in the lattice, each receiving input from a randomly selected 3-dimensional weather feature vector 1102. Each of K weather feature vectors 1102 has dimension 3 in this example. The weights at each neuron (node), also of dimension 3, are adjusted according to a training procedure. Mathematically, given

xₖ=historical set of weather feature vectors(k=1,2,K) (1)

wⱼ=node j synaptic weight vector(j=1,2, . . . J), (2)

The lattice is scanned node by node, and a winning node, i(x), is determined by the following equation:

i(x)=arg minⱼ∥x−wⱼ∥j=1,2, . . . ,J (3)

The weights of all nodes are adjusted after each random input vector exposure according to the following equation:

wⱼ(n+1)=wⱼ(n)+η(n)Λᵢ₍ₓ₎(n)[xₖ−wⱼ(n)] (4)

Here,

η(n)=max[ηₘᵢₙ,η₀exp(−n/n_{α})] (5)

where
η(n)=learning rate,
ηₘᵢₙ=minimum learning rate,
n_{α}=number of time steps for e folding η decay, and
Λᵢ₍ₓ₎ (n)=max [Λₘᵢₙ, Λ₀ exp[−D(i(x), i*)/L], where
Λᵢ₍ₓ₎ (n)=neighbourhood factor,
Λₘᵢₙ=minimum neighbourhood factor,
L=e folding Gaussian length scale, and
D(i(x), i*)=distance between winning node, i(x), and node i, in node coordinates.

After the training is complete, each node may be assigned a subset of historical weather features that exhibit similar weather. Since there are far more feature vectors than nodes, the collection of feature vectors that are closest to each node's weight vector may form a collection of historical analog subsets. The subset of business metrics, matched in time with a particular historical analog subset, characterizes the weather risk at that node.

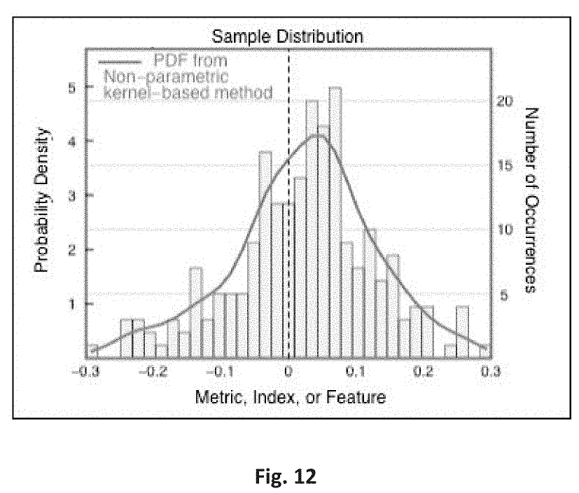

FIG. 12 illustrates a sample histogram with non-parametric PDF construction. Probability distribution functions (PDFs) and their integrated cumulative distribution functions (CDFs) are calculated for weather indices, features, and business metrics. These distributions represent the full historical dataset and sample subsets of values associated with the SOFM map nodes. All distribution functions are calculated using a non-parametric kernel-based method described below: The histogram shows the number of occurrences of some weather index, weather feature, or business metric within 35 bins spanning the abscissa (x-axis) shows the distribution of a sample of data values. The PDF, which approximates the probability density of the sample population, is given by the following equation:

$$p ( x ) = \frac{1}{N} {\sum }_{n = 1}^{N} \frac{1}{{( 2 π {h}^{2} )}^{d / 2}} exp \{ - \frac{{( x - {x}^{n} )}^{2}}{2 {h}^{2}} \} \qquad ( 6 )$$

In this equation, p(x) is the probability density at abscissa value x, and
xⁿ=the n^{th} value from a sample of size N
d=the number of dimensions of x (in this case d=1)
h=a window width parameter (in this example h=0.0024)

In an embodiment, the distributions calculated as part of the WRM analysis use 75 bins to span the abscissa and a window width of 6% of the span. These two parameters are adjustable. The window width has the effect of smoothing irregularities in the histogram that arise due to the limited sample sizes.

When plotting PDFs of node samples (historical analog subsets) against the PDF of the full historical sample's “population,” the question arises as to the significance of any differences in the distributions. Weather risk occurs when these differences are statistically significant. Because a node of sample size, M, is considerably smaller than the historical sample size, and there is some chance that a randomly drawn sample of size M from the population does not differ from the distribution calculated from the node's sample.

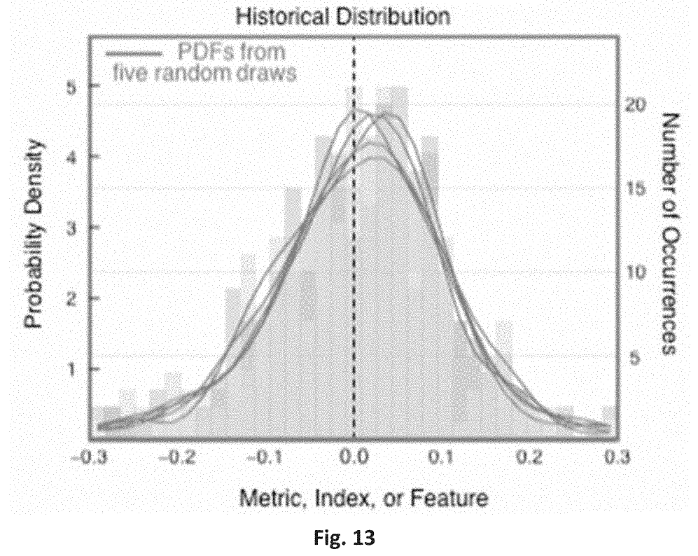

FIG. 13 illustrates an example of five random draws of sample size M from the historical distribution, in accordance with an embodiment of the present disclosure. To quantify the statistical level of certainty that the node distribution differs from the historical distribution, 99 randomly drawn samples of size M may be drawn from the historical data, and their PDFs may be constructed for five random draws. Envelopes of the 5th and 95th ranked random PDF values at each value of the abscissa provide a range of PDF values within which the sample PDF is not statistically significant at the 95% level. A sample PDF less than or exceeding this envelope at each value of the abscissa is statistically significant at the 95% level. Envelopes of the 10th and 90th ranked random PDF values provide limits where the sample PDF is statistically significant at the 90% level. Similarly, envelopes of the 25th and 75th ranked random PDF values provide limits where the sample PDF is statistically significant at the 75% level.

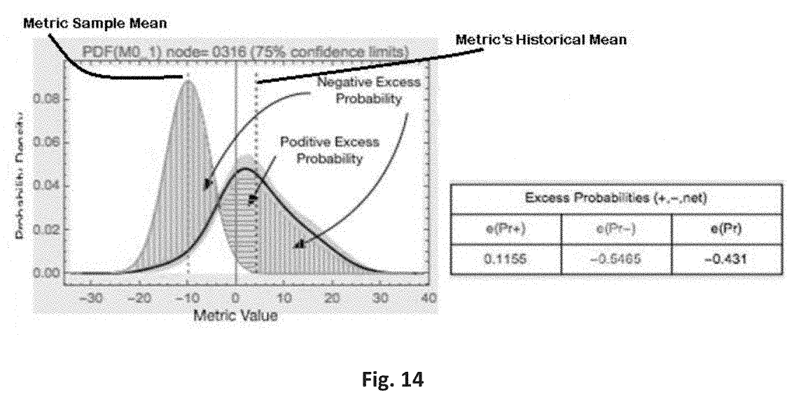

The excess probability at each value of the abscissa is positive where the sample's probability density exceeds the upper envelope limit and negative where the sample's probability density falls below the lower envelope limit. This excess probability is used to quantify the efficacy of the weather risk assessment, as described with reference to FIG. 14. The historical business weather and its associated business metric(s) has been discretized by the SOFM algorithm into a 1- or 2-dimensional feature map. The distribution of the metric differs across the feature map according to the metric's weather sensitivity. Weather sensitivity is seen as a positive or negative excess probability of the node's metric distribution relative to the probability of the historical distribution. As illustrated in FIG. 14, the efficacy of the weather risk assessment is the excess probability summed over all nodes of the feature map.

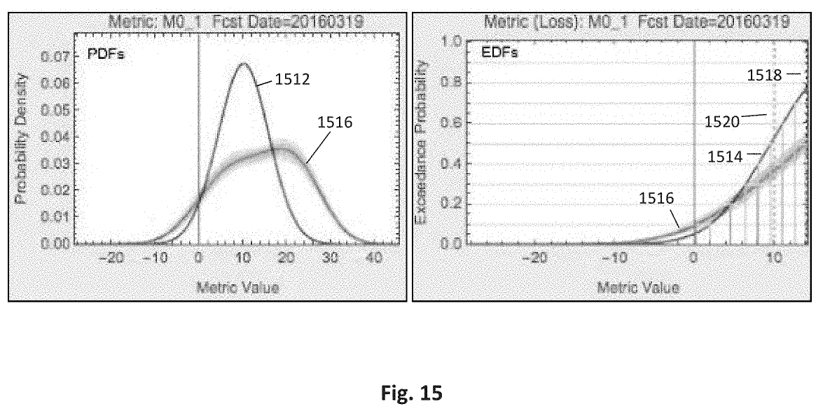

Excess probability is calculated at the 95%, 90%, and 75% confidence levels. Excess probability relative to the metric's historical mean (its expectation) is shown by horizontal lines for positive excess, and vertical lines for negative excess, as illustrated in FIG. 14. In this example, if the metric represents profit, weather risk exists at this node and is quantified as the net excess probability [e(Pr)=e(Pr+)−e(Pr−)]. In the example below, the expected profit distribution is negatively shifted relative to the historical mean by a probability measure of 43.1%. The quantity e(Pr) is more readily apparent in terms of probability exceedance plots. The PDF of the metric distribution is formed by a weighted average of metric distributions at all nodes occupied by the members of the ensemble forecast. Expressed as CDFs, the exceedance distribution function (EDF) of business metric loss can be graphically depicted. FIG. 15 illustrates examples of a business metric's PDF and EDF distribution respectively for a future forecast date. Note that on these distribution plots 1512 and 1516 band surrounding the historical distribution 1510 and 1514 is depicted to assess the statistical significance of the metric's sample distribution shift relative to the historical distribution.

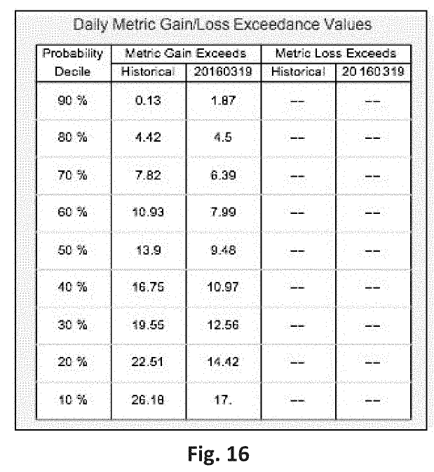

Tabulated values from the EDF are available from the front-end as loss and gain probabilities in various formats. The table associated with the EDF in FIG. 15 is shown in FIG. 16. Note that in this example the historical distribution of the business metric has an expectation of about 14 metric units (1518 dashed line on the diagram's right boundary) and rarely shows a loss (metric value less than zero). The expectation of the forecast metric distribution (1520 dashed line) is lower than the historical value, yet still shows a profit and even a lower probability of a loss. Instead of a 50% chance of a profit exceeding 13.9 units, there is only between a 20% and 30% chance of exceeding this profit level. Quantitative data provided in the tables are available in exportable text formats, which are very useful for incorporating into external risk mitigation software.

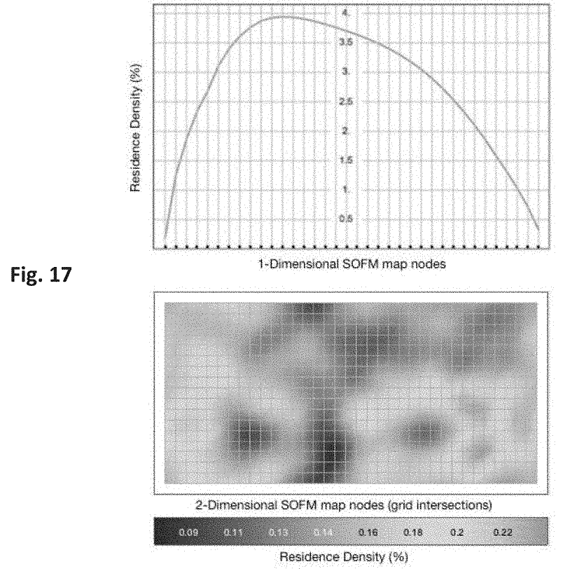

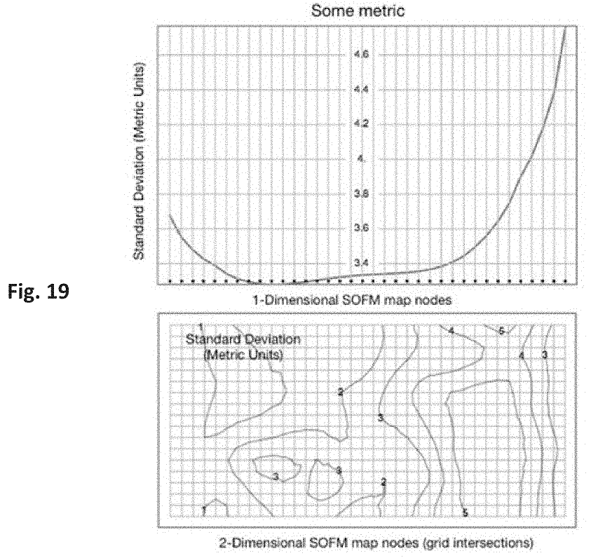

Some of the primary SOFM maps available at the front-end are illustrated and explained in FIGS. 17-25. The SOFM maps display either the residence density, which does not depend on the business metric, the expectation, or the standard deviation of the business metric. FIGS. 17, 18 and 19 illustrate examples of these three displays, respectively, for both 1-dimensional and 2-dimensional SOFM maps. Once the SOFM algorithm has been trained using the historical business weather, distribution of the business weather indices and features are produced for all nodes of the SOFM map.

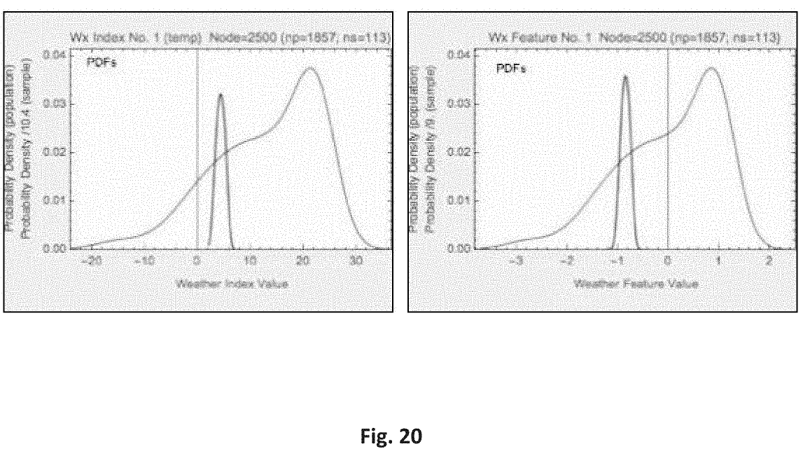

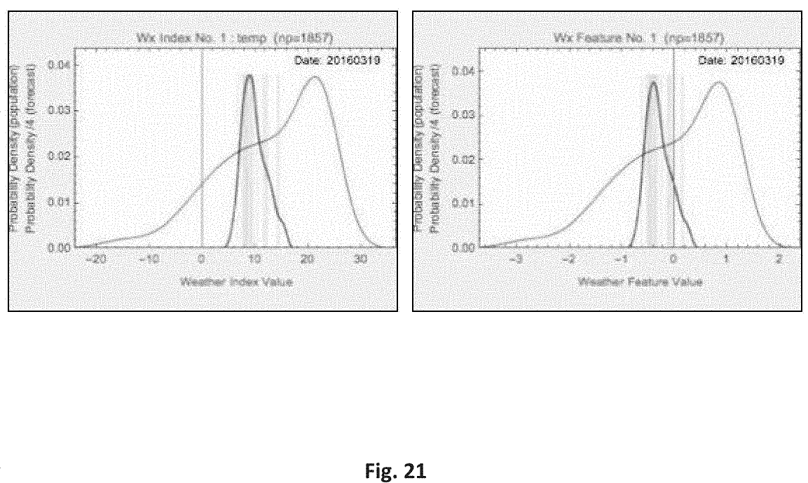

Sample displays of the distributions of the business weather indices and features for all nodes of the SOFM map are illustrated in FIG. 20. The same information is shown for a particular forecast date (five days into the future) in FIG. 21. The ensemble forecast data consists of 21 separate forecasts, and the fact that these forecasts diverge somewhat is seen in the broadening of the sample distributions, which are formed by weighted averages of the distributions from the various nodes occupied by the forecast business weather.

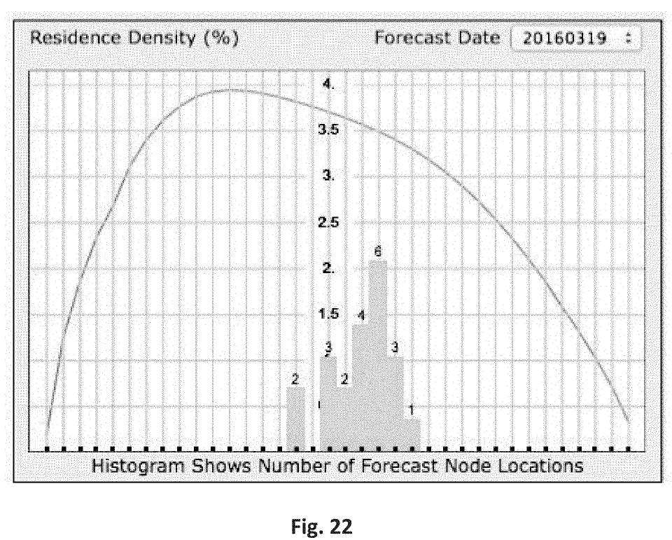

The SOFM residence density map associated with this particular forecast date is shown in FIG. 22. The shaded histogram indicates the number of times that a particular node is occupied by members of the forecast ensemble.

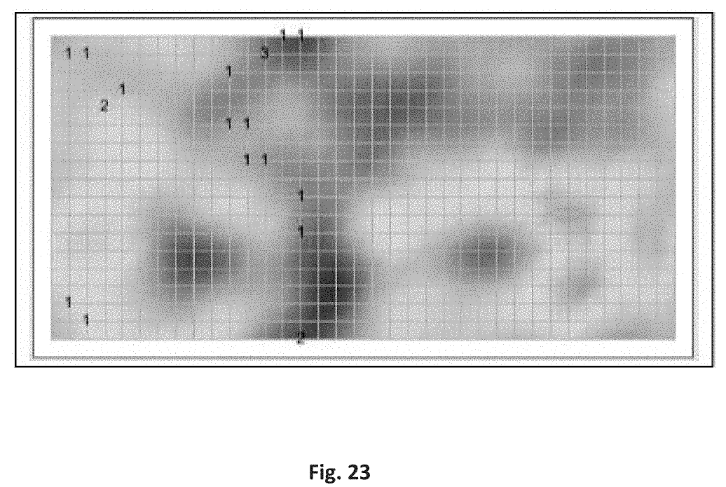

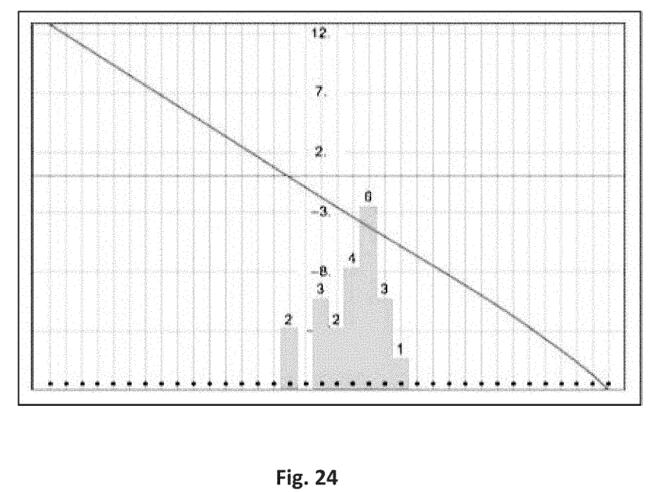

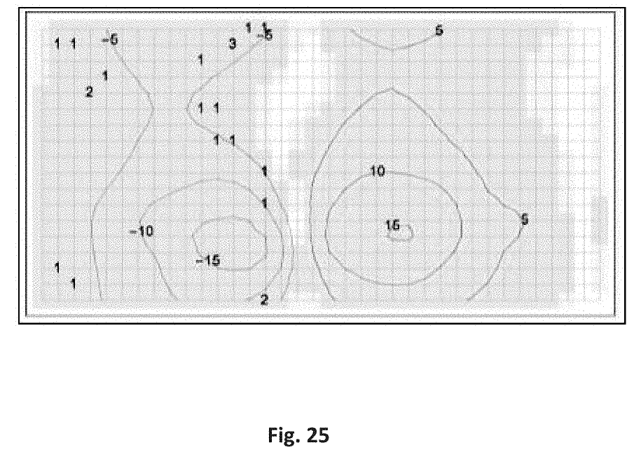

FIG. 23 illustrates the manner in which multiple nodes are occupied on a SOFM residence density plot for a 2-dimensional application. In these examples, only the weather indices and features have been illustrated. The same types of display may be generated for business metric. The SOFM maps illustrated in FIG. 23 are not dependent on the business metric. FIGS. 24 and 25 depict the business metric expectation on the 1- and 2-dimensional SOFM maps for the same forecast period.

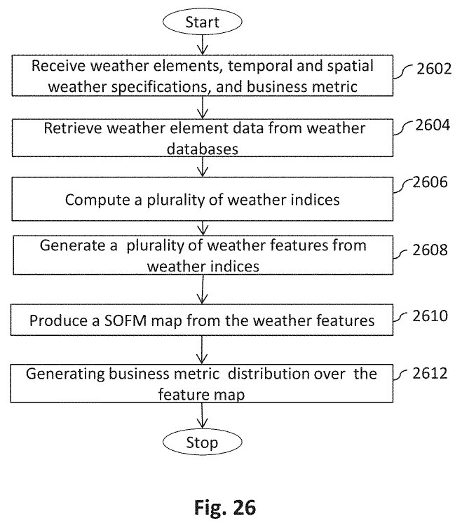

FIG. 26 is a flowchart illustrating a method for estimating and mapping weather risk, in accordance with an embodiment of the present disclosure.

At 2602, one or more weather elements, one or more temporal and spatial weather specifications, and one or more business metric are received from a user.

At 2604, weather element data is retrieved from one or more weather databases based on user input.

At 2606, a plurality of weather indices are generated by processing the weather element data through the one or more temporal and spatial weather specifications, the plurality of weather indices being a plurality of n-dimensional weather feature vectors.

At 2608, dimension reduction of the plurality of weather indices is performed to generate a time series of one or more weather features.

At 2610, the one or more weather features are mapped in a spatially coherent fashion onto a grid of nodes of a Self Organizing Feature Map (SOFM), each node being associated with an analog set of weather features.

At 2612, business metric distribution for each node's set of analog set of weather features is generated based on the one or more business metric.

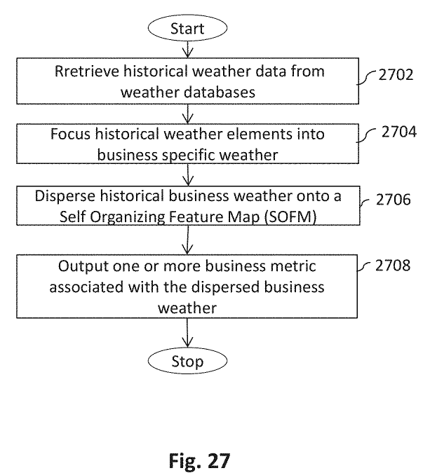

FIG. 27 is a flowchart illustrating a method for estimating and mapping weather risk, in accordance with another embodiment of the present disclosure.

At 2702, historical weather data is retrieved from weather databases.

At 2704, a plurality of historical weather elements is focused into business specific weather using one or more temporal and spatial processing templates.

At 2706, historical business weather is dispersed onto a Self Organizing Feature Map (SOFM) in an ordered fashion.

At 2708, one or more business metric associated with the dispersed business weather are outputted.

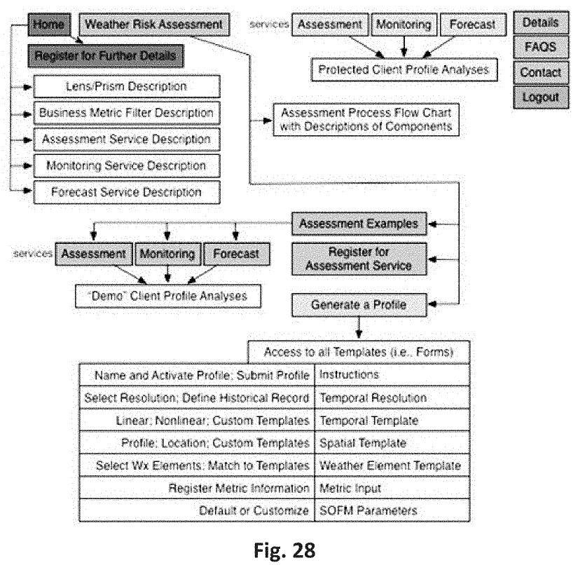

FIG. 28 illustrates an overview of the web page structure and content of the WRM application executed in the WRM server of FIG. 1, in accordance with an embodiment of the present disclosure.

The website of the WRM server 104 is the front-end of the WRM applications. Its public access provides considerable detail of the weather assessment process. It also provides “demo” client analysis results including weather risk assessment and daily updated monitoring and forecasts for the “demo” clients. Potential clients therefore have the ability to fully understand the concept underlying the weather risk analysis procedure and the results that are available to them as subscribers to the service. For non-licensed users, the process of creating a profile for analysis requires registration and payment of a fee that includes WRM consulting during the profile creation, and sufficient iterations of the weather risk assessment to capture whatever weather risk the business is facing. The Licensed clients pay a flat monthly fee that allows creation and analyses of an unlimited number of profiles. These users access the same front-end WRM software through a browser that accesses all of the pertinent files off a local computer, provided as part of the licensed service. The users only access to the web is for automatically downloading the latest data sets to fulfill the weather risk monitoring and forecast functionality. All historical data used in the weather risk assessment is stored locally on a WRM-provided RAIDS disk system that receives monthly uploads directly from WRM. The discussion in the following sections pertains both to the publicly viewable website on the Internet and to the locally run website on a licensed user's browser.

Website Components: The website consists of 16 HTML pages, most of which have dynamic content, using JavaScript. The pages accessing all of the analyses are filled with different intensity shades. The services i.e. Assessment, Monitoring, Forecast, Generate a profile are subscriber private access through password protection. These pages and all supporting JavaScript are duplicated in private and public directories with the “demo” clients accessed through the public directory. The public directory containing comprehensive detailed descriptions is also password protected, accessed, with no obligation, by interested users who register with WRM. In many cases, communications between pages requires passing arguments within the URL. Such arguments include flags indicating whether the client directory is a demo or subscriber, the current source page of the target page, the target page, the current client name, the current client profile, and, for licensed users, the client list.

Static (or nearly static) Web Pages:
a) Register for Further Details page: The page, registerDetails.html, is accessible from the home page. Examination of a detailed description of the WM procedures requires only a name and email registration with WRM. There is no obligation to subscribe to any of the services.
b) Register for Assessment Service page: The page, register.html, is only accessible from the (public) Weather Risk Assessment page. It opens up a contact form for email submission. Registration with WRM is required for access.
c) Details page: This page, public/details/details.html, contains five tabs that provide additional details on the data processing, the SOFM algorithm, the definition and use of historical analogs, statistical methods used and a record of the software version history. Registration with WRM is required for access.
d) FAQS page: This page, public/faqs/faqs.html, contains three tabs with frequently asked questions and answers related to the WRM nomenclature, the analysis procedure, and other concerns. Registration with WRM is required for access.
e) Contact page: The page, public/contact/contact.html, contains five tabs—“About Us,” “Inquiries,” “Register for Weather Risk Assessment,” “Feedback: WebMaster,” and “Feedback: Contact/Support.” Registration with WRM is required for access.
f) Logout link: This link logs out clients accessing the analyses from the Internet.

Dynamic Web Pages:
a) Home page: The page, index.html, provides a brief overview of WRM. It includes a description of the transformation of weather data and business metrics into weather risk viewed through a lens/prism/filter context, and describes the three weather risk services: Assessment, Monitoring, and Forecast. It also provides links to .pdf documents containing overviews of the WRM procedures and services, and a link to a registration page, which allows access to a more detailed explanation of the WRM assessment, monitoring, and forecast procedures.
b) Weather Risk Assessment page: The page, public/wraoverview/example.html, provides greater detail on the weather risk assessment procedure, providing a dynamic flow chart of the major components that make up the assessment procedure.
c) Assessment Examples page: This page, public/wraoverview/example.html, provides a means of examining demonstration analyses. When accessing this page, links are directed toward the public/directory and the content is viewed as if the user were a licensed user, i.e., a list of “demo” clients with different weather risk analyses appears in drop-down format.
d) Generate a Profile page: Within this page, private/assess-gen/assess-gen.html, a subscriber or licensed user creates a profile (i.e., a set of input files) by following the steps on the “instructions” tab. Specifying temporal resolution, temporal and spatial template information, weather element selection, metric input, and SOFM parameters is accomplished by working through the remaining six tabs. Within each tab, further instructions are provided.
e) Assessment page: This page, private/assessment/assessment.html, and its public/directory replica contain a description of the page content on the first tab (“Contents”) and a summary of the profile(s) input on the second tab. The third tab contains diagnostic information on the SOFM procedure. The fourth tab provides a discussion of the business metric distribution display, and shows the metric distribution at each node of the SOFM mesh with reference to the historical metric distributions. Via a drop-down menu, this information (obtained via links at each node) is shown on an SOFM mesh displaying the anomalous metric expectation, the metric standard deviation, and the residence density. The fifth tab provides a description of the efficacy calculation in terms of excess probability at various nodes. Via a drop-down menu, this tab also provides the tabulated efficacy at three confidence levels and, for each node, provides—at the same confidence levels—the sample metric expectation and historical expectation and the excess probability.
f) Monitoring page: This page, private/monitoring/monitoring.html, and its public/directory replica contain results of the profile's weather risk over the most recent week. The first tab provides a description of the content of the remaining two tabs. The next tab shows on the SOFM mesh displaying the residence density, the location of the nodes occupied by the recent seven days. Clicking on each node allows viewing the node and historical distributions of the weather index and weather feature for the days when the business weather resides at that node. In a similar manner, the third tab allows viewing the business metric distribution at each node with reference to the historical business metric distribution. Additionally, exceedance distributions of the metric gain and loss at each node relative to the historical metric gain and loss are shown. Tabulated values of the exceedance distributions are available for both gain and loss in image format and two printable ASCII formats. The .csv format is readily incorporated into spreadsheets for a risk analysis of a portfolio of weather risk profiles.
g) Forecast page: This page, private/projection/projection.html, and its public/directory replica contain results of the profile's weather risk over the 16-day forecast period. The first tab provides a description of the content of the remaining two tabs. The next tab shows on the SOFM mesh displaying the residence density, the location of the nodes occupied by all 21 members of the forecast ensemble over each of the 16 forecast days. Selecting a forecast date from a drop-down menu allows viewing the ensemble-member-weighted node distribution and historical distribution of the weather index and feature for that date. The third tab is similar to the second tab except that distributions of business metrics are shown. Selecting a forecast date from a drop-down menu allows viewing the ensemble-member-weighted node distribution and historical distribution of the business weather for that date. Additionally, exceedance distributions of the metric gain and loss at each node relative to the historical metric gain and loss are shown. Tabulated values of the exceedance distributions are available for both gain and loss in image format and two printable ASCII formats. The .csv format is readily incorporated into spreadsheets for a risk analysis of a portfolio of weather risk profiles.

Software Component Descriptions: The software components constituting the back-end processing consist of UNIX scripts, FORTRAN code and all supporting subroutines, and C code whose main purpose is to run Mathematica® functions through a communication protocol known as MathLink®. The scripts, which control all of the processing, are run either manually or automatically. The current manual script execution can be set up to run automatically, with appropriate checks on data availability and process completion.

Scripts:

For this system, the processes are UNIX scripts written for a variant of the C-shell. These contain statements that define script variables, access external file contents, move or copy files from one location to another, and execute FORTRAN or C code. The data flow within a script is sequential from the first statements to the exit statement, which terminates the script execution. Within the sequence of script commands are various loop, if-then, and while constructs. A list of all scripts and their functions is discussed in following section.

(a) Monthly processing scripts: Usually, on the second day of each month, global reanalysis (REAN) files have been updated to contain all meteorological data from the first of the year through the most recently completed month. These files, available at ftp.edc.noaa.gov/Datasets/ncep.reanalysis/, are manually downloaded. About one week later, the North American Regional Reanalysis (NARR) files become available for the most recent month from http://rda.ucar.edu/datasets/ds608.0/. The following four scripts preprocess these two data sources:

1) rean-raw2bin4: This script reads six sets of seven annual binary REAN files using an NCEP-supplied ncdump utility to extract the weather element data. It then executes a FORTRAN code, binary-var4.f to distribute the weather elements on a daily basis to the directory data-bin/rean/. The six sets of files consist of: upper air 4× daily data; upper air daily average data; Gaussian grid 4× daily data; Gaussian grid daily average data; 4× daily surface data; and daily average surface data.
2) narr-raw2bin-ucar: This script reads five sets of monthly binary NARR files using the NCEP-supplied wgrib utility to extract the weather element data. It executes three FORTRAN codes to place the 8× daily weather element data into the directory data-bin/narr/as follows: extr-dd1dd2.f extracts from the NARR file name, the range of monthly dates contained in each file; prcs-profile.f places the extracted vertical profile data from the first set of downloaded files into proper daily directories; prcs-nsfc.f places the extracted surface or near-surface data from the remaining four sets of downloaded data into proper daily directories.
3) generate-hstg: This script appends the global historical weather element archive with the latest complete month of REAN data. It also generates secondary weather elements, such as wind speed and direction, from the primary weather elements' u- and v-wind components, and fills in the relative humidity and specific humidity from available weather element data when necessary. The script processing executes the FORTRAN codes gen-hstg-s.f, gen-rhsh-s.f, and gen-wswdg-s.f for surface weather elements, and gen-hstg-p.f, gen-rhsh-p.f, and gen-wswdg-p.f for vertical profile weather elements.
4) generate-hsts: This script appends the North American Regional Reanalysis historical weather element archive with the latest complete month of NARR data. It also generates the secondary weather elements (e.g., wind speed and direction) from the primary weather elements' u- and v-wind components. The script processing executes the FORTRAN codes gen-hsts-s.f and gen-wswds-s.f for surface weather elements, and gen-hsts-p.f and gen-wswds-p.f for vertical profile weather elements. A FORTRAN code ass-hsts-p.f reassembles the data stored within vertical-level-specific files into the proper vertical-level aggregate files before updating the NARR historical record.
   (b) Daily processing scripts: During the day, each day, Global Forecast System (GFS) analysis and 3-hr forecast files are downloaded for each model initialization time (00Z, 06Z, 12Z, and 18Z), as the data become available from the NCEP's server, ftpprd.ncep.noaa.gov. The scripts performing the raw GFS data downloads are, in order of execution, dwnld-gfscheck, dwnld-gfs00, dwnld-gfs06, dwnld-gfs12, and dwnld-gfs18. The 00Z download occurs in the predawn hours. This download is copied to the previous day's directory as a 24Z download, facilitating interpolation to 3-hour intervals for the weather elements that are not available within the 3-hr forecast files. After the 00Z download and verification of the successful downloads of all four daily GFS files, a script gfs-raw2bin is executed as described below. In addition to the GFS files, ensemble forecast files are downloaded beginning in the early morning hours by the scripts change-runstatus, get-ens-grib, and ens-process. The functionality of each of these daily processing scripts is as follows:
1) dwnld-gfscheck: Executed just prior to the GFS 00Z download, this script checks the success of the previous day's 00Z, 06Z, 12Z, and 18Z data downloads. The script repeats the download of any incomplete downloads, and advances the download date in preparation for the new 00Z download.
2) dwnld-gfs00(06)(12)(18): These four scripts sequentially download data from each of the 4× daily model initializations. After the 00Z download, the dwnld-gfs00 calls another script (below) to process the complete set of the previous day's 4× daily GFS data.
3) gfs-raw2bin: This script extracts all of the downloaded GFS data, which are in a packed binary format accessed using the NCEP-supplied utility wgrib2. After extracting all of the weather element data into temporary files, the script calls four FORTRAN codes to assemble the GFS data into global 2p5d and North American 32 km datasets: gfs2p5ds-process2.f to process the global surface weather elements; gfs2p5dp-process.f to process the global vertical profile weather elements; gfs32 kms-process2.f to process the North American surface weather elements; and gfs32kmp-process.f to process the North American vertical profile weather elements.
4) change-runstatus: This script, run automatically just prior to the ensemble forecast download resets flags to activate the download script (below), which is run deactivated at five minute intervals throughout the day. This frequency is necessary as part of the stall/suspension reset function of the download script.
5) get-ens-grib: This script is executed early in the morning when activated and the complete ensemble forecast data initialized for the 00Z run become available from the NCEP server, ftpprd.ncep.noaa.gov. This automatic script is written to overcome download stalls and suspensions that occasionally occur with such a comprehensive download, consisting of 21 sets of 16-day data sets at six hr intervals. After the complete download, the script aggregates the files into 21 forecast sets (one for each ensemble member), and proceeds to extract the weather element data from the packed binary files using the NCEP-supplied utility wgrib2. The script then calls the FORTRAN code ens-process.f, which formats the data into the ensemble forecast data directory structure. The script then calls a FORTRAN code, advance-date.f, to advance the download date in preparation for the following day's download.
6) wrm-prcs: This script performs the weather risk assessment for a new profile and the daily updated monitoring and forecast functions. For an assessment on a new profile, the script reads the user-supplied profile input file (which is generated on the front-end from the browser), creates all of the front-end and back-end files needed for all processes under a “client” directory, reads the user-supplied metric file(s), and sequentially calls numerous executable FORTRAN and C codes to perform the assessment and produce all graphics and data files associated with the assessment. In order of execution, these codes are prep-wxel.f, prcs-wxel.f, plotTseries.c, prcs-wxin.f, sofm.f(sofm1.f), nnb-wx.f, vmdist.f, bmdist.f, plotMetricTseries.c, plotBMdist.c, and plotEfficicacy.c. For the monitoring process, the following FORTRAN and C codes are run: prcs-rcnt.f, plotRVMdist.c, and plotRBMdist.c. For the forecast process, the following FORTRAN and C codes are run: prcs-fcst.f, plotFVMdist.c, and plotFBMdist.c.

FORTRAN Codes:

FORTRAN codes provide the majority of data processing in WRM's functionality, supplemented by some of the Mathematica® functions. This section summarizes the procedures accomplished by the FORTRAN codes:
(a) prep-wxel.f: This code, executed by the script wrm-prcs, reads the text file containing all of the profile input, resetting the historical data beginning period to 1979 if NARR data is specified. The code calls separate subroutines to read and distribute to separate files the resolution input (rtres), temporal template input (rttmp), spatial template input (rstmp), and weather element input (rwxel), and call ancillary subroutines or functions (leap, date3, addate, wdisplay, and chkdate1) to complete the data preparation. The profile data is written to a series of web control files so that their values are displayed on the front-end browser.
(b) prcs-wxel.f: This code, executed by the script wrm-prcs, reads the input information from the separate files created by prep-wxel.f, reads the historical data archive, and generates one or more weather indices from the weather elements by processing the weather element data through the various templates. The code calls various subroutines (rtdata, wename, openbin, datedir, readbin, date3, addate, dailyprcs, appstmp, and appttmp) to accomplish these tasks.
(c) prcs-wxin.f: This code, executed by the script wrm-prcs, reads in the weather index data generated by prcs-wxel.f; standardizes the index data (saving the average, standard deviation, maximum, and minimum values); performs dimensional reduction where necessary, using principal component analysis (saving the eigenvalues and eigenvectors) to produce time series of one or more weather features; and stores the time series of all weather features for further processing. To facilitate this processing step, the code calls the following subroutines: stdz, ccorr, tred2, tqli, indexx, and shuffle.
(d) sofm.f (sofm1.f): This code, executed by the script wrm-prcs, implements the 2-dimensional Self-Organizing Feature Mapping (SOFM) algorithm (sofm1.f is the 1-dimensional version). The code reads in a series of parameters to specify the map configuration (i.e., node configuration within the lattice or mesh) and control the neural network learning process. The SOFM procedure takes a historical weather feature time series, and “maps” the historical record onto the lattice of nodes. Each weather feature in the time series is a vector of one or more dimensions. Each node on the SOFM mesh is assigned an initial random weight vector (matching the dimension of the feature). The historical weather features are randomly presented to the mesh over millions of iterations, and for each iteration, the node containing the weight vector “closest” to the weather feature (in a least-squares sense) wins that iteration. The winning node's weight vector is nudged closer to the weather feature vector and the weight vectors of neighboring nodes are nudged to a lesser extent toward the weather feature's vector. As a result, over millions of iterations, each node becomes associated with a set of weather features (i.e., a historical weather analog set) whose vector values are similar. The sets of historical weather analogs from nearby nodes do not differ substantially as compared to the sets of weather analogs from distant nodes on the map. This SOFM procedure disperses, or “maps,” the historical weather data in a spatially coherent fashion onto a grid of nodes. The functionality is analogous to the function of a prism, which disperses sunlight in an ordered fashion (by wavelength) onto a surface. The sofm.f (sofm1.f) code calls two subroutines (avevar and indexx) and two functions (ran2 and drec) to process the historical weather features. The FORTRAN code is a customized version of the SOFM algorithm described by Haykin (1994) and Freeman and Skapura (1992).
(e) nnb-wx.f: This code, executed by the Mathematica® functions plotSOFM[.] and plotSOFM[.], extracts weather indices and weather features for all “nearest neighbors” at each node of the SOFM mesh for plotting purposes. Although each node of the mesh has an associated historical analog set of weather indices and features, a minimum sample size is imposed on each node's historical analog set. For nodes with smaller analog sets than the minimum, analogs from nearby nodes are borrowed to make up the difference. These borrowed set members are chosen according to their vector distance from the weight vector of the borrowing node. This code writes the values of the weather indices and weather features associated with each node's analog set, and the historical dates for each node's analog set. No subroutines are called by this code.
(f) vmdist.f: This code, executed by the script wrm-prcs, generates the probability density functions and cumulative distribution functions of the population (i.e., historical data at all nodes) of weather indices and weather features. The code also loops over all nodes, generating the sample probability density function and cumulative distribution function for each node's set of historical analogs. The code calls subroutines avevar and pdfcdf to perform these calculations. The pdfcdf subroutine calculates distributions using a non-parametric kernel-based method.
(g) bmdist.f: This code, executed by the script wrm-prcs, generates one metric at a time, the probability density function(s) and cumulative distribution function(s) of the population (i.e., historical data at all nodes) of the business metric(s). It also calculates uncertainty bounds (5%, 10%, 25%, 75%, 90%, and 95%) for the node-specific sample sizes so that the significance in shift in any node's sample metric distribution relative to the population distribution can be ascertained. As in the vmdist.f code, avevar and pdfcdf are called to perform the calculations. Additionally, subroutines ran2 and indexx are called to facilitate the uncertainty bounds calculations, cbmf2n is called to process the metric names, and avgvar is called to calculate the average and standard deviation from the probability density function.
(h) prcs-rcnt.f: This code, executed by the script wrm-prcs, combines procedures from prcs-wxel.f, prcs-wxin.f, and nnb-wx.f, and reads files generated by sofm.f (sofm1.f) to convert recent weather element data onto locations on the SOFM map, one for each of the most recent seven days. Once the locations are known, the metric(s) distributions at that node are identified for display within the browser.
(i) prcs-fcst.f: This code, executed by the script wrm-prcs, performs the same function as prcs-rcnt.f except that 16-day forecasts of weather elements from 21 separate forecasts are processed. The metric distributions provided to the front-end browser are weighted averages of metric distributions at the nodes of the SOFM map. The weights are assigned according to how many of the 21 forecasts occupy each node.

C Codes:

C codes call Mathematica® functions using the communications protocol MathLink®. Their names match the functions called, with the naming convention apparent from the Mathematica® function descriptions. These codes are all executed from the script wrm-prcs, which writes input data to files read within the C codes. Each C code then activates the MathLink® protocol, provides commands to access and then run the functions, and then closes the MathLink® connection. The C codes only provide diagnostic output statements during execution to monitor the completion of the functions called.
(a) plotTseries.c: This code, executed by the script wrm-prcs, reads from input files, the root directory name, the client and profile name, and the number of weather elements. The Mathematica® function plotTseries[.] is then called with these four arguments plus an I/O flag that controls the function's looping over weather elements.
(b) plotMTseries.c: This code, executed by the script wrm-prcs, reads from input files, the root directory name, and the client and profile name. The Mathematica® function plotMTseries[.] is then called with these three arguments plus an I/O flag that controls the function's output file generation.
(c) plotMetricTseries.c: This code, executed by the script wrm-prcs, reads from input files, the root directory name, the client and profile name, and a business metric name. The Mathematica® function plotMetricTseries[.] is then called with these three arguments plus an I/O flag that controls the function's output file generation.
(d) plotBMdist.c: This code, executed by the script wrm-prcs, reads from input files, the root directory name, the client and profile name, a business metric name, the number of weather features, and the number of SOFM nodes in the x- and y-directions. The Mathematica® function plotBMdist[.] is then called within a loop over the y-direction nodes with these seven arguments plus the y-node argument and an I/O flag that controls the function's output file generation.
(e) plotEfficacy.c This code, executed by the script wrm-prcs, reads from input files, the root directory name, the client and profile name, a business metric name, the number of weather features, and the number of SOFM nodes in the x- and y-direction. The Mathematica® function plotEfficacy[.] is then called with these seven arguments and an I/O flag that controls the function's output file generation.
(f) plotRVMdist.c: This code, executed by the script wrm-prcs, reads from input files, the root directory name, the client and profile name, the number of weather elements and the number of weather features, and the number of SOFM nodes in the x- and y-direction. The Mathematica® function plotRVMdist[.] is then called with these seven arguments and an I/O flag that controls the function's output file generation.
(g) plotRBMdist.c: This code, executed by the script wrm-prcs, reads from input files, the root directory name, the client and profile name, the number of weather elements and the number of weather features, and the metric name. The Mathematica® function plotRBMdist[.] is then called with these six arguments and an I/O flag that controls the function's output file generation.
(h) plotFVMdist.c: This code, executed by the script wrm-prcs, reads from input files, the root directory name, the client and profile name, the number of weather elements and the number of weather features, the number of SOFM nodes in the x- and y-direction, and the WRM processing execution date in format yyyymmdd. The Mathematica® function plotFVMdist[.] is then called with these eight arguments and an I/O flag that controls the function's output file generation.
(i) plotFBMdist.c: This code, executed by the script wrm-prcs, reads from input files, the root directory name, the client and profile name, the number of weather elements and the number of weather features, the number of SOFM nodes in the x- and y-direction, the business metric name, and the WRM processing execution date in format yyyymmdd. The Mathematica® function plotFBMdist[.] is then called with these nine arguments and an I/O flag that controls the function's output file generation.

Mathematica® Functions:

Mathematica® functions are written in the Mathematica® language, which contains all of the conventional looping and conditional execution structures, as well as input/output protocols for external files, and a powerful graphics generation capability. The functions listed below are all contained with a Mathematica® notebook, which provides the editing interface. The functions, abc[.] are saved externally as files abc.m for input to the C-codes through the MathLink® protocol. Results of the functions mainly provide graphics files for the browser interface.

Primary Mathematica® Functions:
a) plotTseries[.]: Named for plotting Time series, this function reads the weather index data and plots a multiyear historical time series of each weather element, and generates plots for each year. The function also generates lists of the historical and annualized weather element data with time stamps for downloading.
b) plotMTseries[.]: Named for plotting Mode Time series, this function performs the same processing as plotTseries[.] except that weather feature (here referred to as mode) data are plotted with list files generated.
c) plotSOFM[.]: Named for plotting SOFM information, this function reads numerous files generated by the FORTRAN code executing the SOFM neural-network algorithm and plots diagnostic information related to the SOFM mesh and its content. In particular, the following information is plotted:
   a. The SOFM residence density across the SOFM map. For every node, the distribution of weather indices and features are plotted with reference to the historical distributions.
   b. The evolution of the learning rate and node distance weight parameters over the SOFM training period.
   c. The evolution of the root-mean-squared (rms) winning-node movement and the rms node weight variability during the course of the training period.
   d. The number of times a feature vector was selected over the training period as a function of the feature vector's time index.
   e. An animation of the vector distances from the winning node's vector value of all members of each node-dependent historical analog set.
   f. An animation of the node weight evolution at each node during the training period.
   g. A plot of the mean and standard deviation across all nodes of the SOFM map of each weather index and weather feature. Additionally, for the 1-dimensional SOFM map (described below), the max/min extremes are plotted.
d) plotSOFM1[.]: Named for plotting SOFM1-dimensional information, this function generates the same plot information as described above except pertaining to the 1-dimensional SOFM map.
e) plotVMdist[.]: Named for plotting Variable & Mode distributions, this function plots probability density functions (PDFs) and Cumulative distribution Functions (CDFs) for weather indices (here referred to as variables) and weather features (here referred to as modes). Within this function, plots are generated for the historical distributions with uncertainty bands, and for the distributions associated with each SOFM node's historical analog subset. The distribution plot information is read from files generated by FORTRAN codes.
f) plotMetricTseries[.]: Named for plotting Metric Time series, this function processes the business metric time series data in the same manner described for the function plotTseries[.]. Both plots and ASCII data sets are made available for viewing and downloading.
g) plotBMdist[.]: Named for plotting Business Metric distributions, this function generates the same information as plotVMdist[.] except pertaining to each business metric.
h) plotEfficacy[.]: Named for plotting Efficacy, this function loops over each business metric, examines the metric's distribution at each SOFM node in comparison with the historical distribution (i.e., all nodes) of the metric distribution, and sums the integrated difference between the node's distribution and the historical distribution at various confidence bands over all nodes. The function tabulates these values, and plots, for each node, the excess expectation and probability of the metric(s) over the historical values.
i) plotRVMdist[.]: Named for plotting Recent Variable & Mode distributions, this function identifies the relevant nodes and imports previously generated PDF and CDF plots for the weather indices (variables) and features (modes) for those nodes that are “occupied” for the seven most recent days. Additionally, the function creates weekly-average PDFs and CDFs of the recent weather indices and features.
j) plotRBMdist[.]: Named for plotting Recent Business Metric distributions, this function identifies the relevant nodes and imports previously generated PDF and CDF plots of the business metric(s) for those nodes that are “occupied” for the seven most recent days. Additionally, the function creates weekly-average PDFs and CDFs of the recent business metric. For all relevant plotted distribution data, tabulated values of the excess gain and loss probabilities at decile resolution are made available in printable formats (including EXCEL) for incorporation into user-provided analysis applications.
k) plotFVMdist[.]: Named for plotting Forecast Variable & Mode distributions this function identifies the relevant nodes and imports previously generated PDF and CDF plots for the weather indices (variables) and features (modes) for those nodes that are “occupied” for all 21 ensemble members over the 16-day forecast period. The function calculates a weighted average of the node distributions for the 21 ensemble members because the forecast uncertainty increasingly results in multiple node locations for the ensemble members. Additionally, the function creates week-1, week-2, and week-1&2 PDFs and CDFs of the forecast weather indices and features.
l) plotFBMdist[.]: Named for plotting Forecast Business Metric distributions, this function identifies the relevant nodes and imports previously generated PDF and CDF of the business metric(s) for those nodes that are “occupied” for all 21 ensemble members over the 16-day forecast period. The function calculates a weighted average of the node distributions for the 21 ensemble members because the forecast uncertainty increasingly results in multiple node locations for the ensemble members. Additionally, the function creates week-1, week-2, and week-1&2 PDFs and CDFs of the forecast business metric(s). For all relevant plotted distribution data, tabulated values of the excess gain and loss probabilities at decile resolution are made available in printable formats (including EXCEL) for incorporation into user-provided analysis applications.

Supporting Mathematica® Utility Functions:
(a) pxloc1[.]: This function converts the 1-dimensional SOFM nodeID into x-pixel offsets for plot positioning information.
(b) pxloc2[.]: This function converts the 2-dimensional SOFM nodeID into x- and y-pixel offsets for plot positioning information.
(c) smoothMesh[.]: This function calls a FORTRAN utility code, smooth-mesh.f to provide a distant-dependent 9-point smoother over a 2-dimensional SOFM map and a 5-point smoother over a 1-dimensional grid.
(d) getint[.]: This function provides contour intervals subject to the maximum and minimum values of an array of data values.
(e) date3[.]: This function converts the date in yyyymmdd format to integer values of the year, month, and day.
(f) addate[.]: This function accepts a date in integer year, month, and day format and an integer number of daily increments to add to the date. The returned new date is in the yyyymmdd format. This function handles leap days.
(g) pdfi[.]: This function uses the Mathematics®—provided interpolation method to extract a probability value from a PDF at a given location on the abscissa.
(h) julianDate[.]:This function returns the Julian day (i.e., 1-365 or 1-366) for a given date in yyyymmdd format.

In summary, the present invention provides the updated monitoring of weather risk over a recent period of time and updated forecasts of weather risk for a future period of time. Further, the output of such system should be presented to the user in the simplest, interactive and consistent format that can be interpreted quickly, accurately, and reliably. It is to such a method and system that the present invention is directed.

It will be appreciated that various above-disclosed embodiments, other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

We claim:

1. A computer-implemented method for estimating and mapping weather risk for a business entity, comprising:
receiving one or more weather elements, one or more temporal and spatial weather specifications, and one or more business metric, from a user;
retrieving weather element data from one or more weather databases based on user input;
generating a plurality of weather indices by processing the weather element data through the one or more temporal and spatial weather specifications, the plurality of weather indices being a plurality of n-dimensional weather feature vectors;
performing dimension reduction of the plurality of weather indices to generate a time series of one or more weather features;
mapping the one or more weather features in a spatially coherent fashion onto a grid of nodes of a Self Organizing Feature Map (SOFM), each node being associated with an analog set of weather features; and
generating business metric distribution for each node's set of analog set of weather features, based on the one or more business metric.

2. The computer-implemented method as claimed in claim 1, further comprising:
mapping one or more weather features corresponding to recent and forecasted weather data onto one or more nodes of the SOFM map; and
estimating weather risk as node-dependent business metric distributions that are shifted relative to the business metric distribution associated with historical weather element data.

3. The computer-implemented method as claimed in claim 1, wherein the one or more weather elements includes at least one of: a temperature, a maximum temperature, a minimum temperature, a mean sea-level pressure, a precipitation rate, a specific humidity, and a relative humidity.

4. The computer-implemented method as claimed in claim 1, wherein the one or more business metric includes at least one of: profit, loss, revenue, and labor.

5. The computer-implemented method as claimed in claim 1, wherein the one or more weather databases includes at least one of: historical weather database, recent weather database, and forecast weather database, and weather element data.

6. The computer-implemented method as claimed in claim 1, wherein the one or more temporal and spatial weather specifications are received from the user through one or more temporal and spatial weather template forms.

7. The computer-implemented method as claimed in claim 1, wherein the dimension reduction of the plurality of weather indices is performed using Principal Component Analysis (PCA).

8. The computer-implemented method as claimed in claim 1 further comprising:
updating monitoring of weather risk over a pre-defined time period; and
updating forecasting of weather risk for a predefined future time period.

9. The computer-implemented method as claimed in claim 1, wherein the weather element data includes at least one of: historical weather elements, routinely updated recent weather elements, and ensemble forecast weather elements.

10. A computer-implemented method for estimating and mapping weather risk for a business entity, comprising:
focussing a plurality of historical weather elements into business specific weather using one or more temporal and spatial processing templates;
dispersing historical business weather onto a Self Organizing Feature Map (SOFM) in an ordered fashion; and
outputting one or more business metric associated with the dispersed business weather.

11. The computer-implemented method as claimed in claim 10, wherein the one or more weather elements includes at least one of: a temperature, a maximum temperature, a minimum temperature, a mean sea-level pressure, a precipitation rate, a specific humidity, and a relative humidity.

12. The computer-implemented method as claimed in claim 10, wherein the one or more business metric includes at least one of: profit, loss, revenue, and labor.

13. The computer-implemented method as claimed in claim 10 further comprising:
updating monitoring of weather risk over a pre-defined time period; and
updating forecasting of weather risk for a predefined future time period.

14. A weather risk mapping (WRM) system, comprising:
a weather element selection module configured to receive one or more weather elements from a user;
a temporal and spatial template application module configured to receive one or more temporal and spatial weather specifications from a user;
a weather database module configured to retrieve weather element data from one or more weather databases based on user input;
a weather index computation module configured to generate a plurality of weather indices by processing the weather element data through the one or more temporal and spatial weather specifications, the plurality of weather indices being a plurality of n-dimensional weather feature vectors;
a weather feature generation module configured to perform dimension reduction of alignment plurality of weather indices to generate a time series of one or more weather features; and
a SOFM algorithm module configured to:
map the one or more weather features in a spatially coherent fashion onto a grid of nodes of a Self Organizing Feature Map (SOFM), each node being associated with an analog set of weather features; and
generate business metric distribution for each node's set of analog set of weather features, based on the one or more business metric.

15. The WRM system as claimed in claim 14, wherein the SOFM algorithm module is further configured to:
map one or more weather features corresponding to recent and forecasted weather data onto one or more nodes of the SOFM map; and
estimate weather risk as node-dependent business metric distributions that are shifted relative to the business metric distribution associated with historical weather element data.

16. The WRM system as claimed in claim 14, wherein the one or more weather elements includes at least one of: a temperature, a maximum temperature, a minimum temperature, a mean sea-level pressure, a precipitation rate, a specific humidity, and a relative humidity.

17. The WRM system as claimed in claim 14, wherein the one or more business metric includes at least one of: profit, loss, revenue, and labor.

18. The WRM system as claimed in claim 14, wherein the one or more weather databases includes at least one of: historical weather database, recent weather database, and forecast weather database, and weather element data.

19. The WRM system as claimed in claim 14, wherein the dimension reduction of the plurality of weather indices is performed using Principal Component Analysis (PCA).

20. The WRM system as claimed in claim 14, wherein the weather element data includes at least one of: historical weather elements, routinely updated recent weather elements, and ensemble forecast weather elements.
